(19) United States
(12) Patent Application Publication
(10) Pub. No.: US 2019/0116465 A1
(43) Pub. Date: Apr. 18, 2019

(54) LOCATION SWAPPING BETWEEN DEVICES IN PHYSICAL PROXIMITY

(71) Applicant: SKIA, INC., San Francisco, CA (US)

(72) Inventor: Vitaliy KULIKOV, San Francisco, CA (US)

(73) Assignee: SKIA, INC., San Francisco, CA (US)

(21) Appl. No.: 16/091,086

(22) PCT Filed: Apr. 18, 2017
(86) PCT No.: PCT/US2017/028159

§ 371 Date: Oct. 3, 2018

Related U.S. Application Data
(60) Provisional application No. 62/324,621, filed on Apr. 19, 2016.

(51) Int. Cl. H04W 4/029; H04W 8/00; H04W 4/02; H04W 4/06

(52) U.S. Cl. CPC H04W 4/029; H04W 4/06; H04W 4/023; H04W 8/005

(57) ABSTRACT

A location swapping application running on a first client device scans for location information broadcast by other client devices in proximity to the first client device, the first client device having current location information comprising first location coordinates and a first timestamp. The first client device receives shared location information from a second client device, the shared location information comprising second location coordinates and a second timestamp and compares the second timestamp to the first timestamp. If the location swapping application determines that the second timestamp is more recent than the first timestamp, the application updates the current location information to replace the first location coordinates with the second location coordinates.

### TECHNICAL FIELD

This disclosure relates to the field of electronic devices and, in particular, to location swapping between devices in physical proximity.

### BACKGROUND

Location-based services are a general class of computer program-level services used to include specific controls for location and time data as control features in computer application programs. As such, location-based services have a number of uses in applications and social networking today as an entertainment service, which is accessible with mobile devices through the mobile network and which uses information on the geographical position of the mobile device.

### BRIEF DESCRIPTION OF THE DRAWINGS

The present disclosure is illustrated by way of example, and not by way of limitation, in the figures of the accompanying drawings.

FIG. 1 is a block diagram illustrating a computing environment for location swapping between devices in physical proximity, according to an embodiment.

FIG. 2 is a map diagram illustrating a cluster of client devices and the coverage areas of personal area networks used to swap location information between the client devices, according to an embodiment.

FIG. 3 is a block diagram illustrating a location swapping application running on a client device, according to an embodiment.

FIG. 4 is a flow diagram illustrating method for location swapping between devices in physical proximity, according to an embodiment.

FIG. 5 is a flow diagram illustrating method for location swapping between devices in physical proximity, according to an embodiment.

FIG. 6 is a block diagram illustrating a computer system, according to an embodiment.

### DETAILED DESCRIPTION

The following description sets forth numerous specific details such as examples of specific systems, components, methods, and so forth, in order to provide a good understanding of several embodiments of the present invention. It will be apparent to one skilled in the art, however, that at least some embodiments of the present invention may be practiced without these specific details. In other instances, well-known components or methods are not described in detail or are presented in simple block diagram format in order to avoid unnecessarily obscuring the present invention. Thus, the specific details set forth are merely exemplary. Particular implementations may vary from these exemplary details and still be contemplated to be within the scope of the present invention.

Embodiments are described for location swapping between devices in physical proximity. The solution described herein propagates more recent location information from one client device directly to another client device based on proximity. This is in contrast to conventional systems which use a client-server solution, with the server being responsible for client coordination.

The location swapping techniques described herein can be completely distributed and need not utilize a central server to operate. In one embodiment, two devices that are deemed to be in proximity can each advertise their most recent location and timestamp information and adopt/propagate the more recent information as appropriate. The proximity of two client devices can be determined in a number of different ways. For example, certain personal area network (PAN) wireless technologies have a limited communication range (e.g., approximately 100 meters). When a first device shares location information via these technologies, a second device that receives the location information can be determined to be located in relatively close proximity to the first device, otherwise the second device could not have received the location information.

In one embodiment, each device includes its current location coordinates and a corresponding timestamp as part of its advertisement/broadcast. In addition, each device listens to the advertisements from other devices in proximity and potentially adopts the location information from another device as its own current location if the received location information is more recent, more accurate, etc.

Due to the very limited range of Bluetooth low energy (“Bluetooth LE”), for example, any two devices that can listen to each other can be trusted to be in proximity. Thus, this scheme does not need a centralized server to work. In one embodiment, using Bluetooth LE, each device may broadcast, advertise, or otherwise share its best location estimate. Because of the range of classic Bluetooth LE (˜10 to 100 meters), simply being able to sense Bluetooth LE broadcasts from another device can serve as a proxy for other forms of proximity detection.

By turning on independent location services, such as a global positioning system (GPS) service, on each device periodically (e.g., every 10 or 15 minutes), with each device broadcasting its best location and listening to other devices, it is possible to implement a solution that, in densely-populated areas, approximates GPS location data and is significantly more accurate than Wi-Fi or cell-tower triangulation. If devices are within sufficient proximity of one another (as determined by the Bluetooth LE connectivity), and a GPS location was obtained by one of the devices within a threshold period of time (e.g., within the last several minutes) or when the devices were in proximity, the device can share its GPS location data with other devices in its proximity. If the shared GPS location data received by a second device from the first device is more recently obtained than GPS location data from the second device itself, the second device can use the GPS location of the first device as its own location.

The location-swapping techniques can result in significant savings in device resources, such as battery life and network data usage, since the GPS need only be activated occasionally while still allowing the device to have accurate location information. In addition, because the location-swapping solution, unlike Wi-Fi triangulation, can work device-to-device, Internet connectivity is not required and the solution can therefore work even on devices with no data network or no network coverage at all. Furthermore, the location-swapping solution is difficult to be disrupted by devices maliciously reporting wrong location coordinates. With some simple filtering to ignore any coordinates that are too different (i.e., too far away) and the ratio of “bad” devices to “good” is relatively small, the negative effects of any attack would also be small. Because of the limited broadcast range, a device will be much more likely to encounter more “good” devices than “bad,” which would make any malicious attack quite hopeless.

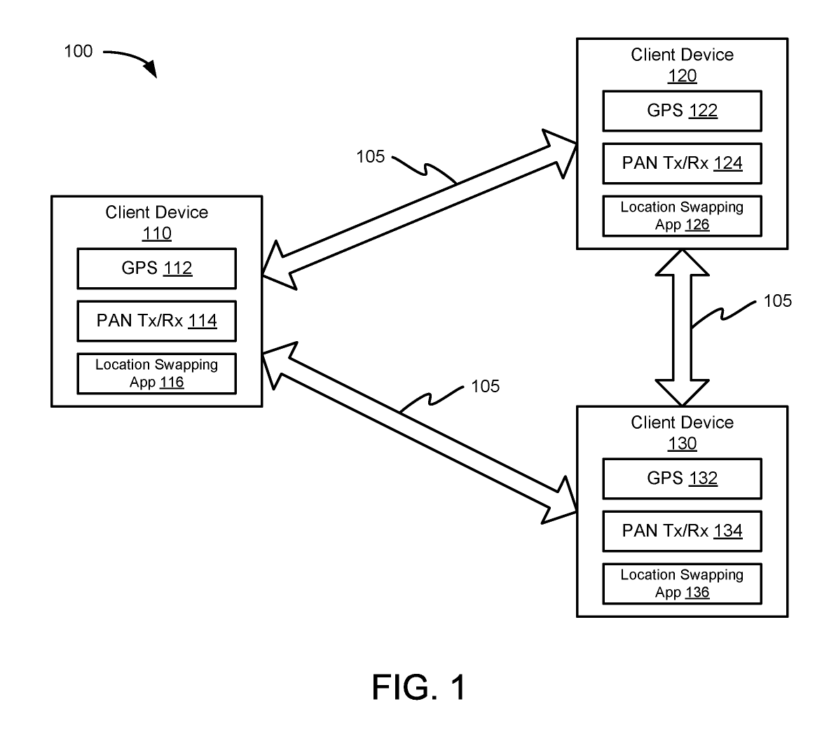

FIG. 1 is a block diagram illustrating a computing environment for location swapping between devices in physical proximity, according to an embodiment. In one embodiment, computing environment 100 includes multiple client devices 110, 120 and 130. Client devices 110, 120, 130 may be connected through a series of one or more personal area networks 105, such as Bluetooth LE, Bluetooth, INSTEON, IrDA, Wireless USB, Z-Wave, ZigBee, etc. In other embodiments, client devices 110, 120 and 130 may be connected by other networks, such as, for example, a public network (e.g., the Internet), a private network (e.g., a local area network (LAN) or wide area network (WAN)), a wired network (e.g., Ethernet network), a wireless network (e.g., an 802.11 network or a Wi-Fi network), a cellular network (e.g., a Long Term Evolution (LTE) network), routers, hubs, switches, server computers, and/or a combination thereof. In another embodiment, client devices 110, 120 and 130 may have a direct connection between them. The illustrated embodiment shows three client devices 110, 120 and 130, however, in other embodiments, there may be any number of client devices, and computing environment 100 may include additional and/or different devices.

Each client device 110, 120 and 130 may be, for example, a personal computer (PC), workstation, laptop computer, tablet computer, mobile phone, personal digital assistant (PDA) or the like. In one embodiment, client devices 110, 120 and 130 may each include an independent location service 112, 122, 132, such as a GPS chip, network triangulation system, etc., and a PAN transceiver 114, 124, 134 used to provide signals to other client devices over PANs 105. The transmitted signals may include, for example, radio-frequency identification (RFID) signals, Bluetooth signals, near field communication (NFC) signals, mobile communications signals, or some other type of communications signal. Additionally, in one embodiment, each client device 110, 120 and 130 may include a location swapping application 116, 126, 136. The location swapping applications 116, 126, 136 can coordinate the location swapping between the client devices in physical proximity to one another. For example, location swapping application 116 can broadcast, using PAN transceiver 114, the location of client device 110, as determined by independent location service 112. In return, location swapping application 116 can receive location information from client devices 120 and 130 via PAN transceiver 114. Location swapping application 116 can determine whether any of the received locations were recorded more recently (i.e., have a corresponding timestamp that is more recent) than the current location of client device 110. If so, location swapping application 116 can adopt the received location and use it as the current location of client device 110. Additional details of location swapping application 116 are provided below.

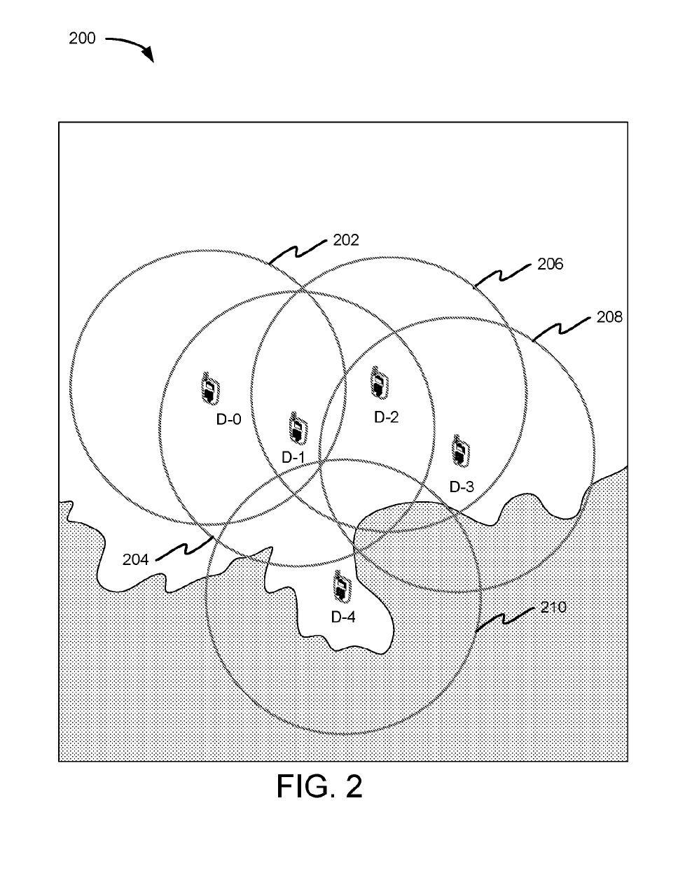

FIG. 2 is a map diagram illustrating a cluster of client devices and the coverage areas of personal area networks used to swap location information between the client devices, according to an embodiment. In one embodiment, the cluster 200 includes client devices D-0, D-1, D-2, D-3, and D-4. These client devices may be representative of any of client devices 110, 120 and 130, as shown in FIG. 1. Each of client devices D-0, D-1, D-2, D-3, D-4 may be configured to broadcast its current location information via a PAN to any other client devices in proximity. For illustration purposes, the signal reach of each broadcast is approximated as a circle 202, 204, 206, 208, 210, respectively, with the associated client device located at the center of each circle. A first client device is assumed to be able to detect or sense the signal from a second client device if the first device is within the signal reach of the second device. For example, device D-0 is assumed to be within reach of device D-1 alone, device D-1 is assumed to be within reach of devices D-0 and D-2, device D-2 is assumed to be within reach of devices D-1 and D-3, device D-3 is assumed to be within reach of device D-2 alone, and device D-4 is not within reach of any other devices. The devices that are within reach (i.e., proximity) of other client devices are able to swap location information utilizing the techniques described herein. For example, if device D-1 is broadcasting location information having a timestamp indicating that it was obtained more recently than the current location information used by device D-0, device D-0 can adopt the location information of device D-1. Since devices D-0 and D-1 are within sufficient proximity (as determined by device D-0 being within reach of PAN 204 of device D-1 and device D-1 being within reach of PAN 2-2 of device D-0), the location information of device D-1 is deemed to be accurate enough for use by device D-0. In the event that device D-0 has not obtained independent location information (e.g., using GPS) for a period of time, the location information of device D-1 is likely more accurate. Additional details of the location swapping process are provided below.

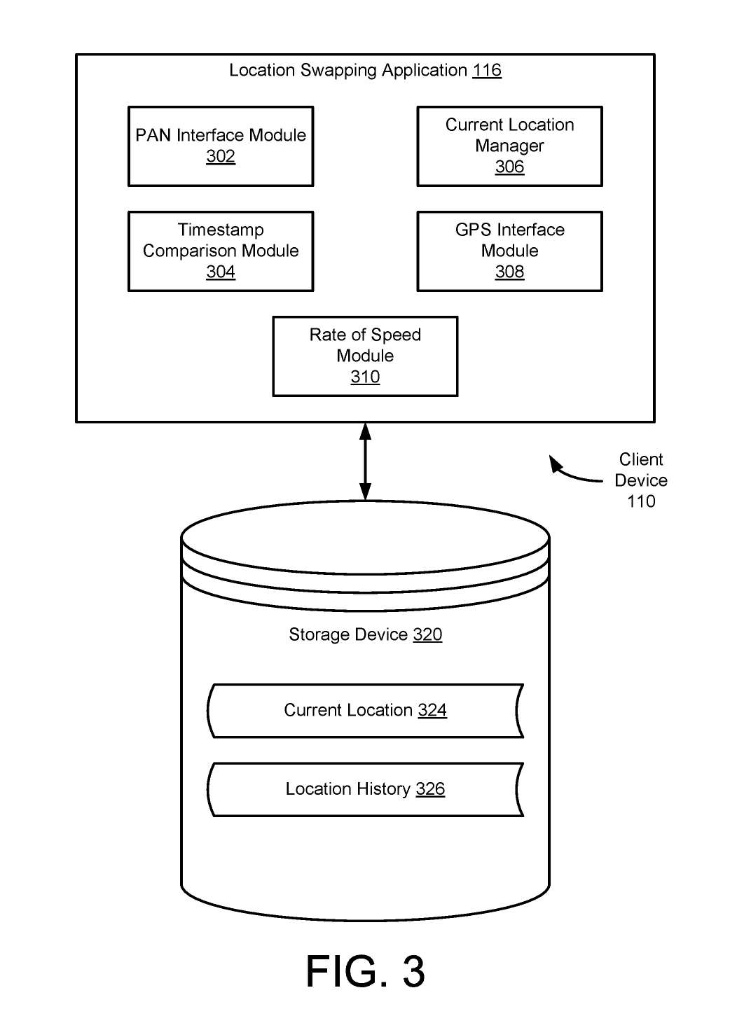

FIG. 3 is a block diagram illustrating a location swapping application running on a client device, according to an embodiment. In one embodiment, location swapping application 116 includes PAN interface module 302, timestamp comparison module 304, current location manager 306, GPS interface module 308, and rate of speed module 310. This arrangement of modules and components may be a logical separation, and in other embodiments, these modules or other components can be combined together or separated in further components, according to a particular implementation. In one embodiment, storage device 320 is connected to location swapping application 116 and includes current location information 324 and location history information 326. In one implementation, client device 110 may include both location swapping application 116 and storage device 320. In another embodiment, storage device 320 may be external to client device 110, and may be connected to client device 110 over a network or other connection. In other implementations, client device 110 may include different and/or additional components and applications which are not shown to simplify the description. Storage device 320 may include one or more mass storage devices which can include, for example, flash memory, magnetic or optical disks, or tape drives; read-only memory (ROM); random-access memory (RAM); erasable programmable memory (e.g., EPROM and EEPROM); flash memory; or any other type of storage medium.

In one embodiment, PAN interface module 302 manages communication over a personal area network 105 of the client device 110. In one embodiment, PAN interface module 302 manages PAN transceiver 114 to broadcast location information over PAN 105, including current location information 324. In one embodiment, the current location information 324 includes location coordinates and a timestamp indicating when the location coordinates were captured. In one embodiment, the current location information 324 is obtained from an independent location service 112 (e.g., a GPS service) running on client device 110. In another embodiment, the current location information 324 is adopted from some other client device, such as client devices 120 or 130. In one embodiment, the current location information 324 can be utilized by an operating system and/or other applications and services running on client device 110. Depending on the embodiment, PAN interface module 302 may broadcast the current location information 324 continuously or periodically.

In addition to broadcasting location information, PAN interface module 302 may further manage PAN transceiver 114 to scan for location information shared by client devices 120 and 130. Client devices 120 and 130 may similarly broadcast their own location information and PAN interface module 302 may periodically activate PAN transceiver 114 to listen for that location information. If client device 110 is within the broadcast range of one or both of client devices 120 and 130, PAN transceiver 114 may be able to receive the broadcast location information. As will be described further below, client device may potentially adopt the shared location information from one of client devices 120 or 130 and use it as the new current location information 324.

In order to determine whether to adopt the shared location information, client device may compare the associated timestamps. In one embodiment, timestamp comparison module 304 compares a timestamp associated with shared location information received from one of client devices 120 or 130 with a timestamp associated with current location information 324. The timestamps represent a time when a corresponding set of location coordinates (e.g., GPS coordinates, latitude and longitude, etc.) was captured by an independent location service. In one embodiment, location coordinates that were obtained more recently can be considered to be more accurate. Thus, client device 110 may adopt the shared location coordinates from one of client devices 120 or 130 if timestamp comparison module 304 determines that the timestamp associated with the shared location information is more recent than the timestamp associated with the current location information 324. In one embodiment, current location manager 306 may update current location information 324 to replace the previous location information with the shared location information received from one of client devices 120 or 130.

In one embodiment, GPS interface module 308 may manage independent location service 112 to periodically update the current location information 324. Even though location swapping application 116 may provide client device 110 with relatively accurate and up-to-date location information, GPS interface module 308 may periodically activate independent location service 112. Since independent location service 112 may utilize extensive battery power, it can be activated only periodically (e.g., every 5, 10, 15, 20 minutes, etc.) rather than being used continuously. In one embodiment, upon expiration of the set period, GPS interface module 308 activates independent location service 112 to obtain updated location information. GPS interface module 308 provides the updated location information to current location manager 306 which may store the updated location information as current location information 324 regardless of what was previously stored as current location information 324. In one embodiment, the period after which GPS interface module 308 activates independent location service 112 may be based on the rate of speed at which client device 110 is moving, as determined by rate of speed module 310. For example, if client device 110 is moving at a faster speed, meaning that its location will be changing more rapidly, GPS interface module 308 may activate independent location service 112 after a shorter period. Conversely, if client device 110 is moving at a slower speed or not moving at all, meaning that its location will be changing more slowly, GPS interface module 308 may activate independent location service 112 after a longer period.

In one embodiment, rate of speed module 310 measures the rate at which client device 110 is moving. In one embodiment, rate of speed module 310 accesses some hardware component of client device 110, such as an accelerometer, to determine the rate of speed. In another embodiment, rate of speed module 310 accesses location history 326 and performs appropriate calculations to determine the rate of speed. For example, rate of speed module 310 may determine the distance between a pervious location from location history 326 and a current location from current location information 324 and divide that distance by the time between when the locations were captured. In one embodiment, rate of speed module 310 compares the determined rate of speed to one or more defined speed thresholds. If the rate of speed exceeds a certain threshold, rate of speed module 310 may cause client device 110 to take certain actions. For example, rate of speed module 310 may cause PAN interface module 302 to stop the broadcasting of the current location information 324 to other client devices. Since client device 110 is moving relatively fast, its current location information 324 is likely no longer accurate, so it may no longer be shared. In another embodiment, rate of speed module 310 may cause PAN interface module 302 to still transmit the current location information 324, but with an accuracy score to indicate that the location information might be of lower accuracy. In one embodiment, the accuracy score is a value based on one or more factors including, the rate of speed at which the client device is moving, how long since the current location information 324 has been updated, whether the location information was captured by independent location service 112 or whether it was adopted from another client device, a density of client devices in a particular area, etc.

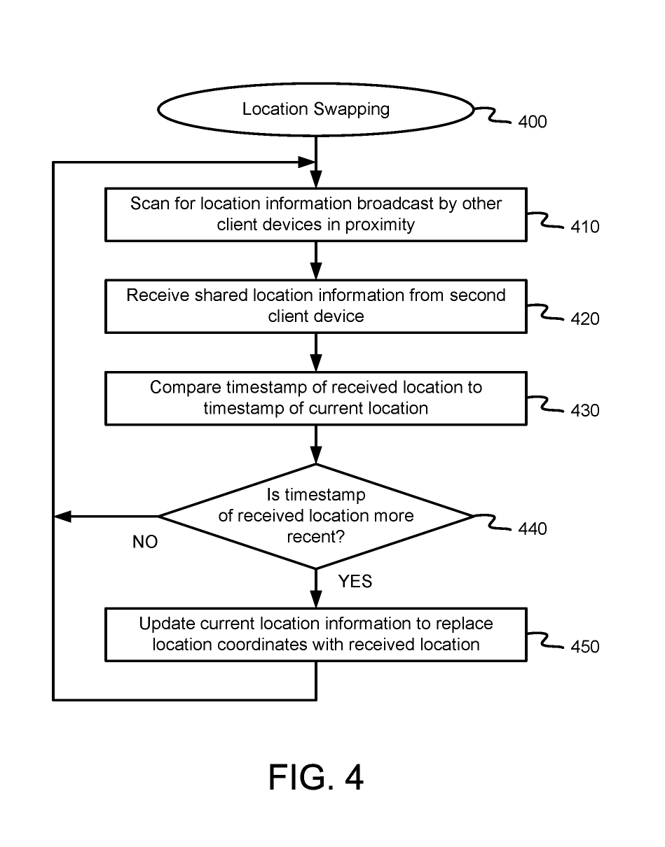

FIG. 4 is a flow diagram illustrating method for location swapping between devices in physical proximity, according to an embodiment. The method 400 may be performed by processing logic that comprises hardware (e.g., circuitry, dedicated logic, programmable logic, microcode, etc.), software (e.g., instructions run on a processing device to perform hardware simulation), or a combination thereof. In one embodiment, method 400 may be performed by location swapping application 116 running on client device 110, as shown in FIGS. 1 and 3.

Referring to FIG. 4, at block 410, a first client device 110 scans for location information broadcast by other client devices 120 and 130 in proximity to the first client device 110. In one embodiment, PAN interface module 302 manages PAN transceiver 114 to scan for location information shared by client devices 120 and 130. Client devices 120 and 130 may broadcast their own location information and PAN interface module 302 may periodically activate PAN transceiver 114 to listen for that location information.

At block 420, the first client device 110 receives shared location information from a second client device 120. If client device 110 is within the broadcast range of one or both of client devices 120 and 130, PAN transceiver 114 may be able to receive the shared location information. The shared location information may include second location coordinates and a second timestamp corresponding to the second client device 120.

At block 430, the first client device 110 compares the second timestamp to the first timestamp. In one embodiment, the first client device 110 has current location information comprising first location coordinates and a first timestamp. In one embodiment, timestamp comparison module 304 compares the second timestamp associated with shared location information received from one of client devices 120 or 130 with the first timestamp associated with current location information 324. The timestamps represent times when corresponding sets of location coordinates were captured.

At block 440, the first client device 110 determines whether the second timestamp is more recent than the first timestamp. In one embodiment, location coordinates that were obtained more recently can be considered to be more accurate. Thus, client device 110 may adopt the shared location coordinates from one of client devices 120 or 130 if timestamp comparison module 304 determines that the timestamp associated with the shared location information is more recent than the timestamp associated with the current location information 324.

If the second timestamp is not more recent than the first timestamp, method 400 returns to block 410. If the second timestamp is more recent than the first timestamp, at block 450, the first client device 110 updates the current location information to replace the first location coordinates with the second location coordinates. In one embodiment, current location manager 306 may update current location information 324 to replace the previous location information with the shared location information received from one of client devices 120 or 130. The previous location information may be stored as part of location history information 326.

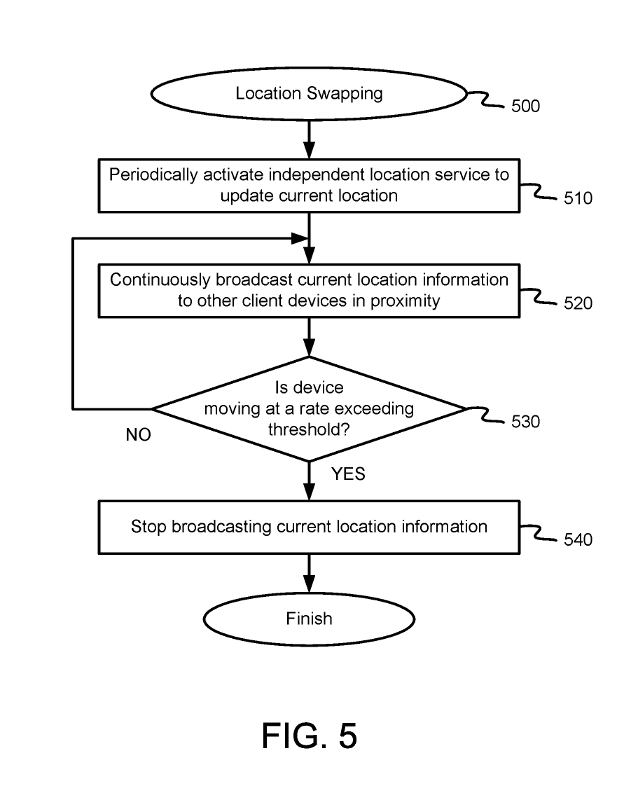

FIG. 5 is a flow diagram illustrating method for location swapping between devices in physical proximity, according to an embodiment. The method 500 may be performed by processing logic that comprises hardware (e.g., circuitry, dedicated logic, programmable logic, microcode, etc.), software (e.g., instructions run on a processing device to perform hardware simulation), or a combination thereof. In one embodiment, method 500 may be performed by location swapping application 116 running on client device 110, as shown in FIGS. 1 and 3.

Referring to FIG. 5, at block 510, the first client device 110 periodically activates the independent location service 112 on the first client device 110 to update the current location information. In one embodiment, GPS interface module 308 may manage independent location service 112 to periodically update the current location information 324. To prevent excessive resource utilization by independent location service 112, GPS interface module 308 may activate independent location service 112 periodically (e.g., every 5, 10, 15, 20 minutes, etc.). In one embodiment, upon expiration of the set period, GPS interface module 308 activates independent location service 112 to obtain updated location information. GPS interface module 308 provides the updated location information to current location manager 306 which may store the updated location information as current location information 324 regardless of what was previously stored as current location information 324.

At block 520, the first client device 110 continuously broadcasts the current location information to the other client devices 120 and 130 in proximity to the first client device 110. In one embodiment, PAN interface module 302 manages PAN transceiver 114 to broadcast location information over PAN 105, including current location information 324. In one embodiment, the current location information 324 includes location coordinates and a timestamp indicating when the location coordinates were captured.

At block 530, method 500 determines whether the first client device 110 is moving at a rate exceeding a defined threshold. In one embodiment, rate of speed module 310 measures the rate at which client device 110 is moving. In one embodiment, rate of speed module 310 compares the determined rate of speed to one or more defined speed thresholds. If the rate of speed exceeds a certain threshold, rate of speed module 310 may cause client device 110 to take certain actions.

If the first client device 110 is not moving at a rate exceeding the defined threshold, method 500 returns to block 520. If the first client device 110 is moving at a rate exceeding the defined threshold, at block 540, the first client device 110 stops the broadcasting of the current location information. In one embodiment, rate of speed module 310 may cause PAN interface module 302 to stop the broadcasting of the current location information 324 to other client devices. Since client device 110 is moving relatively fast, its current location information 324 is likely no longer accurate, so it may no longer be shared.

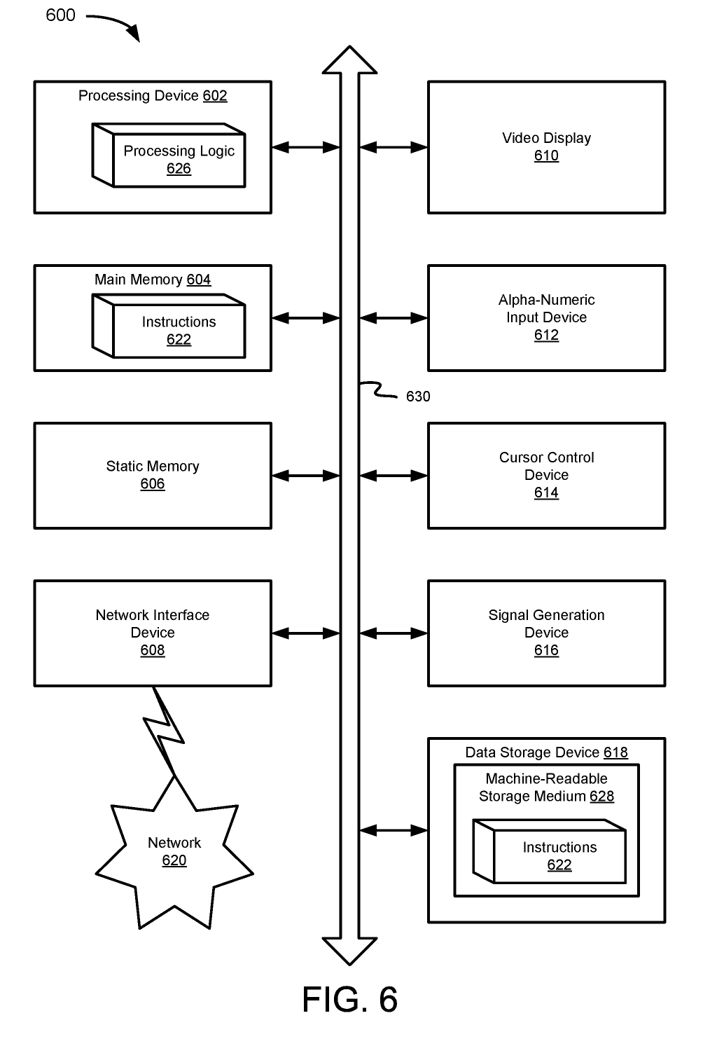

FIG. 6 illustrates a diagrammatic representation of a machine in the exemplary form of a computer system 600 within which a set of instructions, for causing the machine to perform any one or more of the methodologies discussed herein, may be executed. In alternative embodiments, the machine may be connected (e.g., networked) to other machines in a local area network (LAN), an intranet, an extranet, or the Internet. The machine may operate in the capacity of a server or a client machine in a client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. In one embodiment, computer system 600 may be representative of a computing device, such as client devices 110, 120, 130, running location swapping applications 116, 126, 136.

The exemplary computer system 600 includes a processing device 602, a main memory 604 (e.g., read-only memory (ROM), flash memory, dynamic random access memory (DRAM) (such as synchronous DRAM (SDRAM) or Rambus DRAM (RDRAM), etc.), a static memory 606 (e.g., flash memory, static random access memory (SRAM), etc.), and a data storage device 618, which communicate with each other via a bus 630. Any of the signals provided over various buses described herein may be time multiplexed with other signals and provided over one or more common buses. Additionally, the interconnection between circuit components or blocks may be shown as buses or as single signal lines. Each of the buses may alternatively be one or more single signal lines and each of the single signal lines may alternatively be buses.

Processing device 602 represents one or more general-purpose processing devices such as a microprocessor, central processing unit, or the like. More particularly, the processing device may be complex instruction set computing (CISC) microprocessor, reduced instruction set computer (RISC) microprocessor, very long instruction word (VLIW) microprocessor, or processor implementing other instruction sets, or processors implementing a combination of instruction sets. Processing device 602 may also be one or more special-purpose processing devices such as an application specific integrated circuit (ASIC), a field programmable gate array (FPGA), a digital signal processor (DSP), network processor, or the like. The processing device 602 is configured to execute processing logic 626 for performing the operations and steps discussed herein.

The computer system 600 may further include a network interface device 608. The computer system 600 also may include a video display unit 610 (e.g., a liquid crystal display (LCD) or a cathode ray tube (CRT)), an alphanumeric input device 612 (e.g., a keyboard), a cursor control device 614 (e.g., a mouse), and a signal generation device 616 (e.g., a speaker).

The data storage device 618 may include a machine-accessible storage medium 628, on which is stored one or more set of instructions 622 (e.g., software) embodying any one or more of the methodologies of functions described herein. The instructions 622 may also reside, completely or at least partially, within the main memory 604 and/or within the processing device 602 during execution thereof by the computer system 600; the main memory 604 and the processing device 602 also constituting machine-accessible storage media. The instructions 622 may further be transmitted or received over a network 620 via the network interface device 608.

The machine-readable storage medium 628 may also be used to store instructions for location swapping between devices in physical proximity, as described herein. While the machine-readable storage medium 628 is shown in an exemplary embodiment to be a single medium, the term “machine-readable storage medium” should be taken to include a single medium or multiple media (e.g., a centralized or distributed database, and/or associated caches and servers) that store the one or more sets of instructions. A machine-readable medium includes any mechanism for storing information in a form (e.g., software, processing application) readable by a machine (e.g., a computer). The machine-readable medium may include, but is not limited to, magnetic storage medium (e.g., floppy diskette); optical storage medium (e.g., CD-ROM); magneto-optical storage medium; read-only memory (ROM); random-access memory (RAM); erasable programmable memory (e.g., EPROM and EEPROM); flash memory; or another type of medium suitable for storing electronic instructions.

The preceding description sets forth numerous specific details such as examples of specific systems, components, methods, and so forth, in order to provide a good understanding of several embodiments of the present invention. It will be apparent to one skilled in the art, however, that at least some embodiments of the present invention may be practiced without these specific details. In other instances, well-known components or methods are not described in detail or are presented in simple block diagram format in order to avoid unnecessarily obscuring the present invention. Thus, the specific details set forth are merely exemplary. Particular implementations may vary from these exemplary details and still be contemplated to be within the scope of the present invention.

In the above description, numerous details are set forth. It will be apparent, however, to one of ordinary skill in the art having the benefit of this disclosure, that embodiments of the invention may be practiced without these specific details. In some instances, well-known structures and devices are shown in block diagram form, rather than in detail, in order to avoid obscuring the description.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “determining”, “identifying”, “adding”, “selecting” or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

Embodiments of the invention also relate to an apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions.

The algorithms and displays presented herein are not inherently related to any particular computer or other apparatus. Various general purpose systems may be used with programs in accordance with the teachings herein, or it may prove convenient to construct a more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

It is to be understood that the above description is intended to be illustrative, and not restrictive. Many other embodiments will be apparent to those of skill in the art upon reading and understanding the above description. The scope of the invention should, therefore, be determined with reference to the appended claims, along with the full scope of equivalents to which such claims are entitled.

What is claimed is:

1. A method comprising:
scanning, by a first client device, for location information broadcast by other client devices in proximity to the first client device, the first client device having current location information comprising first location coordinates and a first timestamp;
receiving, by the first client device, shared location information from a second client device, the shared location information comprising second location coordinates and a second timestamp;
comparing, by a processing device of the first client device, the second timestamp to the first timestamp;
determining, by the processing device, that the second timestamp is more recent than the first timestamp; and
updating, by the processing device, the current location information to replace the first location coordinates with the second location coordinates.

2. The method of claim 1, wherein the first location coordinates are captured by an independent location service running on the first client device at a time represented by the first timestamp.

3. The method of claim 2, further comprising:
periodically activating the independent location service on the first client device to update the current location information.

4. The method of claim 1, wherein the first location coordinates are received from one of the other client devices in proximity to the first client device.

5. The method of claim 1, wherein the first client device and the other client devices share location information directly over a personal area network.

6. The method of claim 1, further comprising:
continuously broadcasting the current location information to the other client devices in proximity to the first client device.

7. The method of claim 6, further comprising:
determining that the first client device is moving at a rate exceeding a defined threshold; and
stopping the broadcasting of the current location information.

8. A first client device comprising:
an independent location service;
a memory;
a processing device operatively coupled to the memory, the processing device to:
scan for location information broadcast by other client devices in proximity to the first client device, the first client device having current location information comprising first location coordinates and a first timestamp;
receive shared location information from a second client device, the shared location information comprising second location coordinates and a second timestamp;
compare the second timestamp to the first timestamp;
determine that the second timestamp is more recent than the first timestamp; and
update the current location information to replace the first location coordinates with the second location coordinates.

9. The first client device of claim 8, wherein the first location coordinates are captured by the independent location service at a time represented by the first timestamp.

10. The first client device of claim 9, wherein the processing device further to:
periodically activate the independent location service on the first client device to update the current location information.

11. The first client device of claim 8, wherein the first location coordinates are received from one of the other client devices in proximity to the first client device.

12. The first client device of claim 8, wherein the first client device and the other client devices share location information directly over a personal area network.

13. The first client device of claim 8, wherein the processing device further to:
continuously broadcast the current location information to the other client devices in proximity to the first client device.

14. The first client device of claim 13, wherein the processing device further to:
determine that the first client device is moving at a rate exceeding a defined threshold; and
stop the broadcasting of the current location information.

15. A non-transitory machine-readable storage medium storing instructions which, when executed, cause a processing device to perform operations comprising:
scanning, by a first client device, for location information broadcast by other client devices in proximity to the first client device, the first client device having current location information comprising first location coordinates and a first timestamp;
receiving, by the first client device, shared location information from a second client device, the shared location information comprising second location coordinates and a second timestamp;
comparing, by the processing device of the first client device, the second timestamp to the first timestamp;
determining, by the processing device, that the second timestamp is more recent than the first timestamp; and
updating, by the processing device, the current location information to replace the first location coordinates with the second location coordinates.

16. The non-transitory machine-readable storage medium of claim 15, wherein the first location coordinates are captured by an independent location service running on the first client device at a time represented by the first timestamp.

17. The non-transitory machine-readable storage medium of claim 16, the operations further comprising:
periodically activating the independent location service on the first client device to update the current location information.

18. The non-transitory machine-readable storage medium of claim 15, wherein the first location coordinates are received from one of the other client devices in proximity to the first client device.

19. The non-transitory machine-readable storage medium of claim 15, wherein the first client device and the other client devices share location information directly over a personal area network.

20. The non-transitory machine-readable storage medium of claim 15, the operations further comprising:
continuously broadcasting the current location information to the other client devices in proximity to the first client device.
